(19) United States
(12) Patent Application Publication
(10) Pub. No.: US 2004/0182854 A1
(43) Pub. Date: Sep. 23, 2004

(54) Parallel type heater woven by stranded heating elements

(76) Inventor: Tae-Moon Kim, Pusan (KR)

Correspondence Address: JACOBSON HOLMAN PLLC, 400 SEVENTH STREET N.W., SUITE 600, WASHINGTON, DC, 20004, US

(21) Appl. No.: 10/481,514

(22) PCT Filed: Jun. 25, 2002
(86) PCT No.: PCT/KR02/01204

(51) Int. Cl. H05B 3/34; H05B 3/54

(52) U.S. Cl. 219/545; 219/529

(57) ABSTRACT

The present invention relates to the process for making cloth-like woven heater and its structure of heating element which is wound around a yarn to thereby take a shape of coil spring, and so exhibits excellent and durability.

### BACKGROUND OF THE INVENTION

1. Field of the Invention

The present invention relates to the shape of heating elements in the cloth-like woven heater and the making process of the cloth-like woven heater.

2. Description of Related Art

Generally, the heater conventionally being used connected with a series circuit, such as electric blanket, seat heater and heating mat stops its all function when any part of the heating element of the heater is broken or damaged.

the cloth-like woven heater (registered in Korean Utility Model Registration No1100067, issued to the same applicant as in this invention) consists of a parallel circuit, and so exhibits the following advantages:

Even if some heating elements are broken, only broken parts are not heated, which do not stop the whole function;

Since the load is divided equally by the plural heating elements arranged in parallel, the Watt-density (w/r²π) of the heating elements is decreased relatively, thereby their life is substantially prolonged;

Since the synthetic electric resistance value becomes a reciprocal number of the reciprocal of the total electric resistance value of the plural heating elements (Rt=1/1/R₁+1/R₂+1/R₃ . . . +1/Rn), it assures an accurate electric resistance value, which is nearly constant even at the time of heating.

Even in case when some heating elements are gradually broken in use, the total electric resistance value of the heater is rather increased to remove the trouble owing to the local overheating.

As the woven heater has the cloth-like structure, it has such a soft feeling as cloth without any protrusion.

In spite of the above goodness, however, the cloth-like woven heater has a following disadvantages together.

The straight type heating elements could be broken easily because of being bent and extended repeatedly along the weight of moving object in the place, such as a heating bed, a heating sofa, a heating seat, and so forth;

In order to decrease the range of change of the electric resistance value according to the breakage of heating elements, it is necessary that the number of heating elements arranged in parallel should be more increased, and the electric resistance value of heating element should be set very high, and the thickness of the heating element should be more thin down owing to the electric resistance value of the heating element is inversely proportional to the thickness of the heating element.

And, in case where the extremely thin heating element which has very high electric resistance value and flexibility comes into use for weaving, it could be easily broken on a count of the damage caused by the friction with a reed (yarn guide, loom parts) and a tension applied to the heating elements during the weaving,

And, in case where the more heating elements come into use for weaving, there is a problem too that as the electric resistance value attained according to the number of plural heating elements arranged in parallel becomes a reciprocal number of the reciprocal of the total electric resistance value (Rt=1/1/R₁+1/R₂+1/R₃ . . . +1/Rn), the woven heater's electric resistance value is drastically reduced.

### OBJECTS AND SUMMARY OF THE INVENTION

Solving above-described problems, it is the object of the present invention that replacing the straight type heating element with the winding-structured heating element wound around a yarn to take a shape of coil spring, thereby improving the tensile strength and the resistibility against fold.

And it is the object of the present invention that increasing the number of heating elements arranged in parallel as much as capable by using the extremely thin heating element having a substantially high electric resistance value by aid of tensile strength of a yarn and an increment of its electric resistance value according to the pi(π) of a yarn and turn times around a yarn.

And it is the object of the present invention that for the purpose of maximizing a flexibility of heating element, dividing a straight type heating element currently in use into numbers of extremely thin heating elements and then assembling them to be one or twisting them into the same direction and then winding them around a yarn to take a shape of coil spring.

The object of the present invention is to provide a cloth-like woven heater having the structure that plural winding-structured heating elements are woven with conductive metal wires and then crosswise connected in parallel relation with each other.

### DISCLOSURE OF INVENTION

The more illustrating above-mentioned contents in detail like as follows;

First, in case that the heating element having a thickness of 0.15 mm (in case of a nickel-chrome heating element, it has about 61 ohm per 1 meter length) can be divided into several thin heating elements having a thickness of 0.05 mm (in case of a nickel-chrome heating element, it has about 550 ohm per 1 meter length), also can be divided into 9 heating elements on condition that each of them has the same electric resistance value.

Therefore, considering the tensile strength of yarn which is sustaining the heating element, the flexibility arisen from thin down the heating element, and the increment of resistibility against tension and fold after winding, the life of stranded heating element can be even more prolonged with the only use of the single heating element among divided 9 ones than a straight type heating element in the woven heater, therefore, the number of heating elements arranged in parallel can be increased by at least 9 or more times.

Taking a concrete example, in order to compare a straight type woven heater comprised of heating elements each having 0.15 mm in diameter with a winding type woven heater comprised of 0.05 mm diametral heating elements that each of them is wound on the twisted 1000 denier three ply filament yarn, firstly, after cutting above two type woven heaters to the size of 25 cm×35 cm (each has 50 heating elements arranged in parallel) for sample and rubbing it roughly with both hands, we can see following results.

Straight type woven heater exhibits the breakage of about 10% or more out of arranged 50 heating elements with the reciprocating movement of about 350 times, contrarily, winding type woven heater according to the present invention exhibits the breakage of about 4% or less out of them even with the reciprocating movement of about 25,000 times, which proved the most durability.

### BRIEF DESCRIPTION OF THE DRAWING

FIG. 1 is a plane figure illustrating a cloth-like woven heater according to the present invention; and

FIG. 2 is a structure figure of heating element according to the present invention.

### DETAILED DESCRIPTION OF PREFERRED EMBODIMENTS

The main point of the present invention is the parallel type woven heater having numbers of winding-structured heating elements which are crosswise connected with numbers of conductive metal wires in the place of the both heating elements' edges through the weave.

Now, an explanation of present invention is described clearly with reference to accompanying drawings as follows.

First, the cloth-like woven heater 1 according to the present invention is characterized in that the heating element is wound around the yarn. As illustrated in FIG. 2, winding means that the heating element 3 is wound around the yarn 6 to take a shape of coil spring, which is carried out by the winding machine.

Second, the cloth-like woven heater 11 according to the present invention is characterized in that winding-structured heating elements 2 are crosswise woven with the conductive metal wires 5.

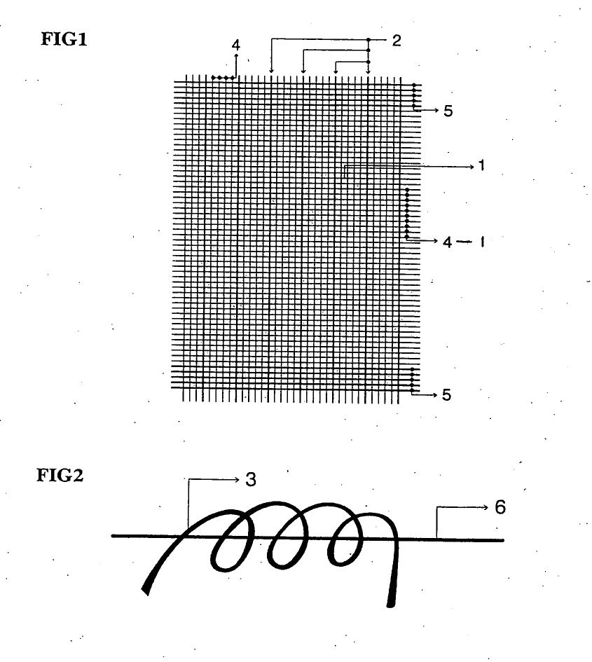

As shown in FIG. 1, heating elements 2, conductive metal wires 5 and cotton yarns 4, 4-1 are woven mutually by dobby loom or jacquard loom (which is capable of using two more colors of weft according to a numerical control program) or looms having equivalent functions.

Generally, the weaving is implemented by the following two methods.

### EXAMPLE 1

The heating elements 2 having mainly a thickness of 0.05 mm to 0.15 mm are arranged in the intervals of the cotton yarns 4 used as the warps, and a single or braided conductive metal wires 5 having mainly a thickness of 0.05 mm to 0.12 mm and the cotton yarns 4-1 are used as the wefts.

While weaving is running, the shuttle of loom carries selectively the cotton yarns 4-1 or the conductive metal wires 5 according to the numerical control program inputted to be woven tightly with the heating elements 2, thereby the cloth-like woven heater 1 as shown in FIG. 1. is produced.

### EXAMPLE 2

The predetermined numbers of conductive metal wires 5 are arranged on the both edges of the loom's reed in the direction of the longitude and the cotton yarns 4-1 are arranged in them, and the cotton yarns 4 and the heating elements 2 are used as the wefts.

While weaving is running, the shuttle of loom carries selectively the cotton yarns 4 or the heating elements 2 according to the numerical control program inputted to be crosswise woven tightly with the conductive metal wires 5, thereby the cloth-like woven heater 1 as shown in FIG. 1 is produced.

What is claimed is:

1. The cloth-like woven heater is characterized by having a process that winding-structured heating elements are arranged in the intervals of the cotton yarns in parallel as warps, while the conductive metal wires and cotton yarns are used as wefts.
Weaving is running, a shuttle of loom carries selectively the cotton yarns or the conductive metal wires according to the program inputted to be woven tightly with the winding-structured heating elements, thereby crosswise linked together and produced conduction bend.

2. The cloth-like woven heater is characterized by having a process that a plural conductive metal wires are arranged on the both edges of loom's reed in the direction of the longitude and cotton yarns are arranged in them, while cotton yarns and winding-structured heating elements are used as wefts.
Weaving is running, a shuttle of loom carries selectively the cotton yarns or the winding-structured heating elements according to the program inputted to be woven tightly with the conductive metal wires, thereby crosswise linked together and produced conduction bend.

3. The cloth-like woven heater is characterized by using the winding-structured heating elements which are fabricated when each of heating elements is wound around a yarn to take a shape of coil spring.

4. The cloth-like woven heater according to claim 3, wherein said winding-structured heating element includes a length of heating element.

5. The cloth-like woven heater according to claim 3, wherein said winding-structured heating element includes the assembled heating element that plural heating elements are assembled into one.

6. The cloth-like woven heater according to claim 3, wherein said winding-structured heating element includes the braided wires that plural heating elements are assembled and twisted into one.

7. The cloth-like woven heater according to claim 3, wherein said winding-structured heating element is the materials which is generating the heat by connection with the electricity.
